(19) United States
(12) Patent Application Publication
(10) Pub. No.: US 2025/0371587 A1
(43) Pub. Date: Dec. 4, 2025

(54) CUSTOMIZED PRICING LOGIC FOR TRANSACTIONS IN AN ENTERPRISE RESOURCE PLANNING SYSTEM

(71) Applicant: COGNITUS CONSULTING LLC, Dallas, TX (US)

(72) Inventor: Christopher Skinner, Aubrey, TX (US)

(73) Assignee: COGNITUS CONSULTING LLC, Dallas, TX (US)

(21) Appl. No.: 19/221,052

(22) Filed: May 28, 2025

Related U.S. Application Data
(63) Continuation-in-part of application No. 18/675,386, filed on May 28, 2024.

(51) Int. Cl. G06Q 30/0283; G06Q 30/04

(52) U.S. Cl. CPC G06Q 30/0283; G06Q 30/04

(57) ABSTRACT

Systems and methods are described for performing real-time billing within an Enterprise Resource Planning (ERP) environment are disclosed. When a transaction posts to an ERP environment, an application retrieves applicable pricing conditions from the ERP system's condition index and compares them to a configuration file that defines filter criteria and pricing procedures. Based on this comparison, the application assigns the transaction to a group and executes the corresponding pricing procedure. Calculated results can be distributed to new line items or routed to other groups for multi-stage evaluation. Final billing values are then persisted for invoicing or reporting.

### CROSS-REFERENCES TO RELATED APPLICATIONS

This application is a Continuation-in-part of patent application Ser. No. 18/675,386 entitled “REAL-TIME PROCESSING OF BILLING TRANSACTIONS FROM AN ENTERPRISE RESOURCE PLANNING SYSTEM”, filed on May 28, 2024, by COGNITUS CONSUTING, LCC, which is herein incorporated in its entirety by reference for all purposes.

### BACKGROUND

Enterprise Resource Planning (“ERP”) platforms, such as SAP, include pricing engines that are used to calculate charges, fees, and other billing amounts based on transactional activity. These pricing calculations are typically governed by a combination of condition records, access sequences, and pricing procedures configured within the ERP system. In many implementations, pricing logic is applied using batch-mode processes such as Resource Related Billing (“RRB”), which re-evaluates pricing for a set of transactions during each billing cycle.

This approach presents several challenges specific to pricing operations. One issue is that ERP pricing procedures are generally static and rigid. Changes to pricing logic—such as applying different rules for different customers, service types, or regions-require direct changes to ERP configuration tables. This can create delays, introduce risk of misconfiguration, and limit responsiveness to evolving business terms or contractual obligations.

Another problem arises from the way ERP systems handle reprocessing. Even when a single transaction changes, the system often reprocesses all related transactions to re-derive pricing results. This consumes considerable system resources and increases the risk of inconsistencies, particularly when pricing conditions are time-sensitive or subject to external dependencies. Additionally, the inability to isolate pricing logic for subsets of transactions prevents differentiated pricing schemes from being applied cleanly or efficiently.

Complex pricing scenarios, such as those involving capped charges, cumulative thresholds, or multi-step discounting, are also difficult to implement using standard ERP tools. Such calculations often require chaining of logic across multiple layers or conditional flows that are not natively supported within the ERP's pricing framework. As a result, organizations may rely on manual workarounds or external calculation tools, leading to fragmentation, latency, and lack of traceability in billing processes.

Accordingly, there is a need for a system and method that enables configurable, real-time pricing calculations to be performed at the point of transaction posting.

### SUMMARY

A system and method are disclosed for real-time billing in connection with transactional records processed by an ERP platform, such as SAP.

Various stages can be performed by an RTB Application that operates as a service layer that plugs into the ERP platform and listens for qualifying transactional events, such as the posting of service confirmations, time entries, or other billing-relevant documents. Upon detection of such a transaction, the RTB Application triggers a process that retrieves applicable pricing condition records from the ERP platform using its built-in condition index structure. These records, which may include condition types, values, and validity dates, are organized into a virtual table and analyzed by the RTB Application to determine whether they match any predefined filters specified in a configuration file.

The configuration file is created and maintained outside the ERP system using an administrative interface of the RTB Application. It defines filters and business rules that isolate subsets of transactions and assign each subset to a Calculation Group, which in turn is associated with a specific pricing procedure. These procedures may include complex calculation logic such as rate determination, conditional surcharges, percentage-based discounts, and contractual threshold enforcement. The pricing procedures can be customized per group and versioned independently of ERP configuration changes, offering flexibility for organizations with diverse billing models.

Once a matching Calculation Group is identified, the RTB Application applies the corresponding pricing procedure to the transaction data. This results in a computed billing amount along with any relevant metadata or intermediate values. If the pricing logic requires redistribution—such as separating amounts that exceed a contractual limit—the RTB Application creates new Request Items or transfers the result to another Calculation Group for further evaluation. This enables multi-level billing logic where downstream calculations can incorporate outputs from prior stages.

At the conclusion of the pricing and distribution stages, the RTB Application finalizes the process by persisting results to long-term storage. This may involve updating the original Request Item with computed values, creating new billing entries, or generating audit logs. The final data is stored in a format suitable for further downstream use, including invoice generation, revenue recognition, and reporting. By replacing traditional batch-based RRB with a real-time, configuration-driven architecture, the RTB Application reduces system load, shortens processing times, and improves the maintainability of complex billing logic within ERP environments.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for providing customized pricing logic in an ERP system.

FIG. 2 is a sequence diagram of an example method for providing customized pricing logic in an ERP system.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

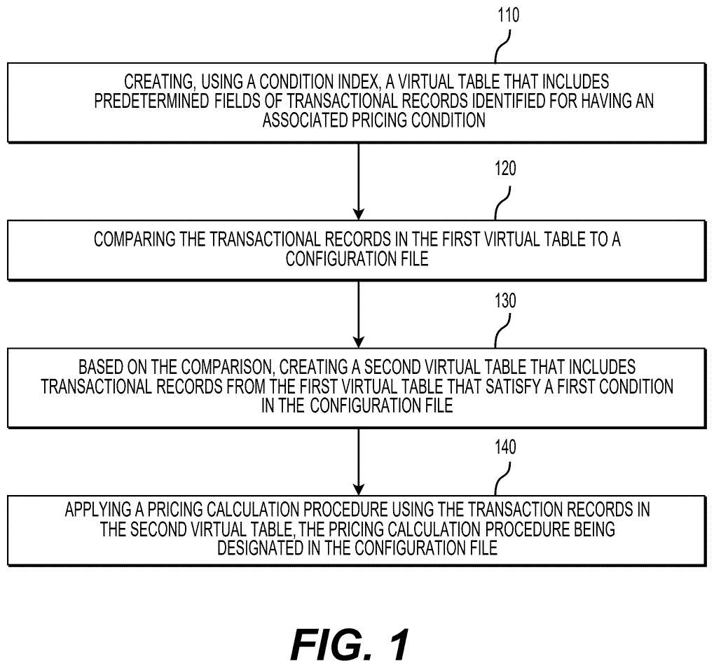

FIG. 1 is a flowchart of an example method for providing customized pricing logic in an ERP system. At stage 110, an RTB application can create, using a condition index of an ERP platform, a virtual table that includes predetermined fields of transaction records identified for having an associated pricing condition. The condition index is a system structure provided by the ERP platform (e.g., SAP) that enables condition-based access to transactional data, such as pricing or cost conditions linked to sales orders, service orders, or other relevant business objects. To enable this functionality, the RTB Application is configured to access and query the condition index using one or more selection criteria corresponding to the predetermined fields of interest. These fields may include, for example, document number, item number, condition type, validity date, and pricing amount. The ERP platform is configured to permit external applications to query the condition index, and appropriate authorization objects and technical interfaces (e.g., Business Application Programming Interfaces (“BAPIs”) or Open Data (“OData”) services) can be enabled to facilitate this access. Additionally, the condition index itself can be set up in the ERP environment to track the relevant pricing conditions for the transaction types being monitored. The virtual table created by the RTB Application functions as a dynamic data structure that aggregates only those transaction records that meet the configured condition criteria, thereby isolating the subset of data necessary for subsequent real-time billing processing steps. In one example, the virtual table can be a core data services (“CDS”) view.

The data tables described herein, such as configuration, logic, and data tables (both virtual and real), can exist either within or outside of the ERP system, depending on the deployment model. For example, in one deployment model, the RTB application is installed directly into the ERP system and becomes an integrated part of its codebase via extensibility mechanisms of the ERP system. In another deployment model, the RTB application is installed in a standalone server, container, or cloud service platform and is connected to the ERP system via Application Programming Interfaces (“APIs”) to send and receive data from the ERP system. This method is required when the ERP system is a multi-tenant system without provisions for on-stack enhancement.

At stage 120, the RTB application can compare the transactional records in the first virtual table to a configuration file. This configuration file is defined and stored within the RTB Application environment prior to the initiation of any transaction processing. Its purpose is to guide the categorization and processing of transaction records by providing a framework of filters and pricing logic tailored to specific business requirements.

The configuration file includes a series of filters that define criteria for isolating subsets of the transaction data. These filters may be based on one or more transaction record fields, including but not limited to customer identifiers, document types, material or service codes, responsible cost centers, sales organizations, or service dates. Filters may include simple field-matching rules (e.g., all records where SalesOrg=1000) or more complex logic involving multiple conditions, such as compound Boolean expressions or value ranges (e.g., CustomerRegion=‘North’ AND ServiceType=‘Field Maintenance’). The RTB Application parses and evaluates each filter sequentially or in parallel, depending on the implementation, and associates matching records with a defined subset.

Each subset identified through this filtering process is linked to a corresponding pricing procedure, which defines how prices or charges are to be calculated for that specific group of transactions. The configuration file may contain references to one or more pricing procedure templates, each of which may include condition types, calculation formulas, pricing scales, surcharges, or discounts applicable to the subset. These pricing procedures may be defined internally within the RTB Application or may reference external pricing schemes managed within the ERP platform itself. The association between filters and pricing procedures allows for the implementation of differentiated billing logic, enabling the RTB Application to apply customized pricing dynamically based on transaction attributes.

The configuration file may be implemented in one of several formats depending on deployment requirements and integration architecture. In one example, the file is structured as an extensible markup language (“XML”) document with hierarchical tags defining each filter set, associated fields, and pricing procedure reference. In another example, the file is formatted as a JavaScript Object Notation (“JSON”) object comprising key-value pairs and nested structures that define filters and their corresponding pricing logic. Alternatively, the configuration may be implemented as a structured table within a relational database or flat file (e.g., CSV) accessible to the RTB Application. The RTB Application can include logic for parsing each of these formats and validating the contents against a defined schema to ensure consistency and correct application of the configuration data.

The RTB Application can retrieve and evaluate each record in the virtual table against the rules defined in the configuration file. If a transaction record satisfies the filtering criteria of one or more subsets, it is flagged or tagged with a reference to the associated pricing procedure. Records that do not match any filter may be excluded from further processing or may be processed using a default pricing rule defined as part of the configuration. This selective tagging mechanism reduces unnecessary processing and ensures that each transaction is handled using contextually appropriate billing logic.

At stage 130, based on the comparison, the RTB application can create a second virtual table that includes transactional records from the first virtual table that satisfy a first condition in the configuration file. This second virtual table can be constructed by extracting a subset of the transactional records from the first virtual table, specifically those records that satisfy a first condition defined in the configuration file. The first condition may correspond to a particular filter or rule defined in the configuration file, such as a field value match, a combination of field values, or a logical expression involving multiple fields of the transaction record.

The second virtual table can function as a runtime data structure that isolates only those transaction records relevant to a specific pricing logic or processing path. For example, if the first condition in the configuration file specifies that records where OrderType=‘ZSER’ and CustomerRegion=‘West’ are to be subject to a defined pricing procedure, the RTB Application identifies all records in the first virtual table that meet these criteria and includes them in the second virtual table. The virtual table can preserve the full data set for each matching transaction record or can include only the fields required for pricing and billing calculations, depending on system configuration and performance considerations.

The process of generating the second virtual table can be repeated for each unique condition defined in the configuration file, allowing the RTB Application to produce multiple virtual tables, each corresponding to a distinct subset of transaction records and associated pricing procedure. These condition-specific virtual tables enable the application to apply pricing logic selectively and efficiently without reprocessing the full transaction dataset.

The group of transaction records in a second virtual table, such as those described above, are referred to hereinafter as a “Calculation Group.”

At stage 140, the RTB application can apply a pricing calculation procedure using the transaction records in the second virtual table, the pricing calculation procedure being designated in the configuration file. The specific pricing calculation procedure to be applied is designated in the configuration file and corresponds to the first condition that was used to generate the second virtual table at stage 130. The pricing calculation procedure may be defined internally within the RTB Application or externally within the ERP platform's pricing framework, and may reference condition types, formulas, or lookup tables used to determine billing values.

The pricing calculation procedure can include one or more defined steps, such as applying base rates, calculating surcharges or discounts, evaluating tiered pricing scales, or referencing time-dependent conditions. These steps can be implemented as discrete modules or rules that operate on field-level data within each transaction record. In some examples, the RTB Application can execute the pricing procedure as a series of rule-based transformations, while in other examples, the application can invoke ERP-native pricing engines using function calls or interface methods.

During this stage, the RTB Application can process each transaction record in the second virtual table using the designated pricing procedure and generates pricing results for each record. These results may include a calculated amount, a breakdown of applied condition types, and metadata indicating the procedure version or timestamp of execution. The resulting pricing data can be stored in association with the corresponding transaction record or request item, and may be used directly for billing, reporting, or audit tracking purposes.

Upon completion of the pricing calculation, the RTB Application can distribute the results for use in subsequent processing. Distribution may be performed to either (i) one or more Request Items or (ii) one or more Calculation Groups. This distribution step enables the integration of calculated pricing outputs into downstream billing processes or into further multi-stage computational logic.

In a first mode of distribution the RTB Application can copy certain condition values-such as surcharges, adjustments, or excess charges—to a new Request Item. This is typically used to implement post-processing business rules that govern contractual or regulatory constraints. For example, if a calculated fee exceeds a contractually defined threshold, the Calculation Group responsible for the pricing evaluation determines the amount by which the fee exceeds the threshold. The excess amount is then distributed to a separate Request Item, allowing for the original Request Item to reflect a capped value while the overflow is recorded and tracked independently. This ensures that the net billable amount associated with the original transaction does not exceed the allowable limit, while preserving a record of the full calculated value and the adjustment applied.

In a second mode of distribution, the RTB Application can route the result of a completed calculation to another Calculation Group. This enables multi-level or chained evaluation, in which the output of one pricing logic path is used as an input to another. For instance, a base service charge calculated in one Calculation Group may be distributed to a downstream Calculation Group responsible for applying a bundled discount or aggregating totals across multiple transactions. By supporting distribution across Calculation Groups, the RTB Application can implement hierarchical or dependent pricing logic while maintaining separation of concerns and modularity in configuration.

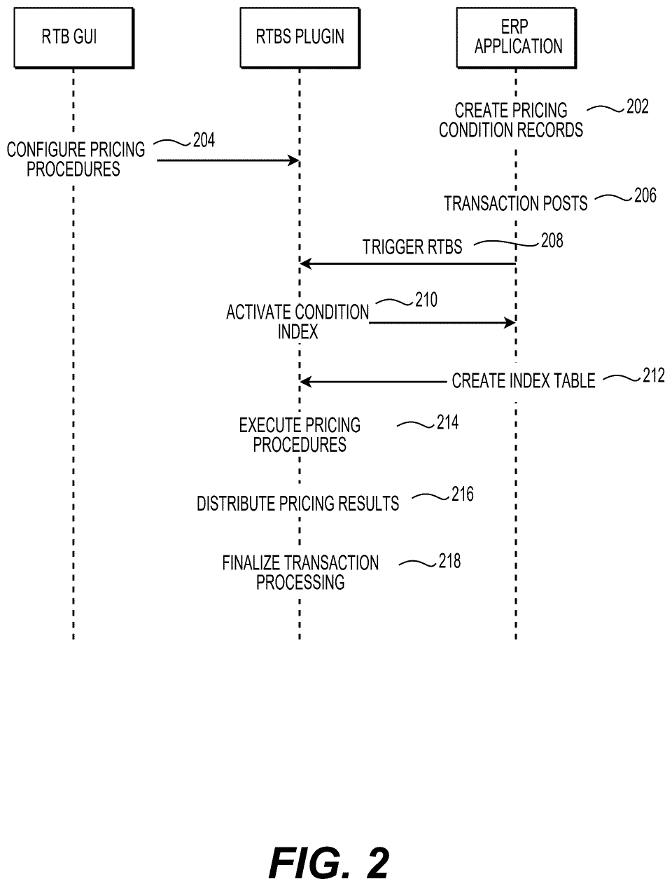

FIG. 2 is a sequence diagram of an example method for providing customized pricing logic in an ERP system. At stage 202, pricing condition records are created within the ERP application. These pricing condition records define the terms, rates, and calculation logic that the ERP platform uses to determine pricing outcomes for transactional data. A pricing condition record may specify, for example, a fixed charge per service unit, a percentage-based discount, a tiered rate structure, or a time-dependent price override. Each condition record typically includes one or more key fields such as a condition type, validity period, access sequence, and reference values tied to specific customers, materials, or service types.

The creation of these pricing condition records may be initiated manually by a user within the ERP platform or programmatically through administrative tools, such as condition maintenance transactions or data load routines. Once created, the records are stored in the ERP platform's condition tables and indexed through the condition index structure, enabling them to be retrieved and applied during pricing evaluations. These records form the pricing logic that will later be referenced by the RTB Service for real-time billing operations.

At stage 204, pricing procedures for Calculation Groups are configured via the RTB GUI and transmitted to the RTB Service. These pricing procedures define how the RTB Service is to perform billing calculations for subsets of transaction records identified during real-time processing. Each pricing procedure may specify a sequence of calculation steps, applicable condition types, thresholds, aggregation methods, and any post-processing distribution logic (e.g., whether to generate a new Request Item or forward results to another Calculation Group).

The configuration can be performed by an administrator or system operator using the RTB GUI, which provides an interface for defining pricing rules and assigning them to Calculation Groups. Each Calculation Group corresponds to a logical classification of transactions that share a common pricing structure. The administrator may also specify filter conditions, evaluation order, and the form of result distribution (e.g., to Request Items or downstream groups) as part of the procedure definition.

Once configured, the pricing procedures are exported or saved in a structured format (e.g., JSON, XML, or a configuration table) and provided to the RTB Service. This may occur through a direct API call, a configuration sync operation, or a push mechanism implemented between the RTB GUI and the RTB Service. Upon receipt, the RTB Service stores the configuration and associates it with the applicable Calculation Groups. These procedures will later be applied to transactional data retrieved from the ERP system during runtime processing.

At stage 206, a transaction posts in the ERP application. This transaction may correspond to any recordable business activity that has financial or billing relevance, such as a service confirmation, time entry, goods issue, or work order completion. When the transaction is posted, it is written to one or more transactional tables in the ERP platform, typically with associated metadata such as timestamps, responsible personnel, service or material codes, and relevant organizational data (e.g., company code, cost center, sales org).

The ERP application may generate additional derived data or update reference tables as part of the standard posting process, depending on the transaction type. The posted transaction is one that includes, or will ultimately be subject to, pricing conditions configured in the ERP system and referenced by the RTB Application.

At stage 208, the posting event triggers the RTB Service. This may occur through a direct event handler, a user exit, or a business add-in (BAdI) configured within the ERP application to notify the RTB Service whenever a qualifying transaction is posted. The trigger passes a payload to the RTB Service containing at least the transaction identifier and sufficient contextual data to allow further evaluation. This may include document numbers, item references, and relevant field values from the ERP tables.

At stage 210, the RTB Service can activate the condition index in the ERP application. Upon being triggered by the posting event at stage 208, the RTB Service initiates a query to the ERP platform's condition index in order to retrieve pricing-relevant data associated with the posted transaction. The condition index is a native ERP mechanism that allows efficient lookup of condition records—such as rates, discounts, and surcharges—based on defined access sequences and key field combinations.

Activation of the condition index may involve executing a read operation against a standard ERP function module or pricing API, supplying key values derived from the posted transaction (e.g., customer ID, document type, material or service code, sales area, etc.). These values form the access keys used by the condition index to identify applicable pricing conditions from the ERP's condition tables (e.g., KONV, KONP, or custom extensions).

The result of this activation is a data set containing condition records relevant to the transaction, including condition types, values, units, and any control flags used during pricing determination. This condition data is used by the RTB Service to populate a virtual table for subsequent filtering and pricing logic execution, as described in earlier stages.

By accessing the ERP condition index in real time, the RTB Service ensures that pricing evaluations are based on the most current and authoritative pricing configuration without duplicating or maintaining separate pricing data outside the ERP system.

At stage 212, the RTB Service can compare the condition index table retrieved from the ERP application to the configuration file received from the RTB GUI. The purpose of this comparison is to determine whether the posted transaction meets any predefined criteria that would cause it to be assigned to a specific Calculation Group and be processed using an associated pricing procedure.

The condition index table, retrieved in stage 210, contains pricing condition records applicable to the posted transaction. These records may include condition types (e.g., base price, discount, surcharge), condition values, validity dates, access keys, and other pricing metadata. The RTB Service loads this data into a temporary structure (e.g., a virtual table or in-memory representation) for evaluation.

The RTB Service then loads the relevant configuration file, which includes filter definitions, assignment rules, and pricing procedures tied to different Calculation Groups. Each filter in the configuration file specifies conditions that must be satisfied by the transactional data or the associated condition records in order to be assigned to a group. For example, a configuration rule may require that the transaction's condition type be a specific value (e.g., “ZBASE”), or that the pricing amount exceed a particular threshold, or that the customer group fall within a designated region.

During the comparison, the RTB Service can iterate through the configuration rules and evaluates them against the data in the condition index table. If a match is found—i.e., if one or more condition records satisfy a given rule—the RTB Service records this match and proceeds to assign the transaction to the appropriate Calculation Group for further processing. If no rules match, the RTB Service may assign a default procedure or flag the transaction for exception handling, depending on the system configuration.

This stage effectively acts as a routing decision point, enabling the RTB Service to dynamically apply differentiated pricing logic based on runtime data and pre-configured business rules.

At stage 214, the RTB Service can execute the pricing procedures associated with the matched Calculation Group. Following the evaluation performed in stage 212, where one or more configuration rules matched the condition index data, the RTB Service identifies the corresponding pricing procedure defined in the configuration file and applies it to the transaction.

Each pricing procedure may consist of a predefined sequence of computational steps that operate on the pricing condition data retrieved from the ERP system. These steps can include arithmetic operations (e.g., addition of surcharges, deduction of discounts), evaluation of pricing scales, enforcement of caps or floors, conditional adjustments based on transaction attributes, and any custom logic defined in the configuration. The procedures may also specify dependencies among condition types or require data transformations before pricing results are finalized.

The RTB Service performs the execution of the pricing logic either within its internal rule engine or by making additional ERP function calls to invoke embedded pricing capabilities, depending on system design. During execution, intermediate values may be stored in memory or in a temporary structure tied to the Calculation Group. The final output of the pricing procedure may include calculated charges, adjusted condition amounts, or flags indicating whether limits were exceeded or exceptions occurred.

At stage 216, the RTB Service can distribute the pricing results, if required by the pricing procedure. Distribution is a conditional step that occurs when the pricing logic executed at stage 214 specifies that the result of a calculation should be transferred to another data structure for further processing or for billing purposes.

There are two primary forms of distribution. In the first form, the RTB Service creates a new Request Item and copies one or more calculated condition values to it. This is typically used in scenarios where a calculated amount must be separated from the original transaction for billing, auditing, or contractual enforcement. For example, if the pricing procedure determines that a charge exceeds a contractual maximum, the RTB Service may split the result, assigning the allowable portion to the original Request Item and the excess portion to a new Request Item. This ensures that the invoiced amount complies with the constraint while retaining a record of the full computed value.

In the second form, the RTB Service distributes the pricing result to another Calculation Group. This allows the system to perform multi-stage or dependent pricing logic, where the output of one pricing procedure serves as input for another. For instance, a service fee calculated in one group might be passed to another group that applies a bundling discount or aggregates charges across multiple transactions. The handoff includes references to the originating transaction and the result values, allowing the downstream group to incorporate the distributed data in its own pricing procedure.

Whether and how results are distributed is defined in the configuration file associated with the originating Calculation Group. The RTB Service interprets this configuration and performs the distribution accordingly, preserving links between the original data and the derived artifacts for traceability and reconciliation.

At stage 218, the RTB Service can finalize the processing of the transaction and persists the results. For example, following the execution of pricing procedures and any distribution operations performed at stage 216, the RTB Service can write the final billing values and related metadata to persistent storage. This can include updating existing Request Items with calculated amounts, creating new Request Items for distributed values, and recording any generated Calculation Group outputs.

The persistence step ensures that all computed results are stored in a durable format and linked to their originating transactions. Data written during this stage can include calculated amounts, applied condition types, pricing procedure identifiers, timestamps, execution statuses, and trace information for audit or reconciliation purposes. The storage may be internal to the RTB Application or written back to the ERP platform, depending on integration design.

Finalization can also include status updates or triggers indicating that the Request Items are ready for downstream processing, such as billing document generation, invoicing, or financial posting. In some implementations, the RTB Service may also write logs, errors, or diagnostic data to a monitoring system for tracking or debugging.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for providing customized pricing logic in an Enterprise Resource Management (“ERP”) environment, comprising:
creating, using a condition index, a first virtual table that includes predetermined fields of transactional records identified for having an associated pricing condition;
comparing the transactional records in the first virtual table to a configuration file;
based on the comparison, creating a second virtual table that includes transactional records from the first virtual table that satisfy a first condition in the configuration file; and
applying a pricing calculation procedure using the transaction records in the second virtual table, the pricing calculation procedure being designated in the configuration file.

2. The method of claim 1, further comprising distributing a result of the pricing calculation procedure by performing at least one of:
creating a new request item and copying one or more condition values from the pricing calculation result to the new request item; or
providing the pricing calculation result as input to a second pricing calculation procedure associated with a different set of transactional records.

3. The method of claim 1, wherein the configuration file includes a plurality of filters, each of the plurality of filters defining a condition for assigning transactional records to a corresponding pricing calculation procedure.

4. The method of claim 1, wherein the configuration file defines, for each condition, a corresponding pricing calculation procedure and a rule set for filtering transactional records based on one or more fields selected from: customer identifier, transaction type, material or service code, region, and effective date.

5. The method of claim 1, wherein the pricing calculation procedure comprises applying a conditional rule that adjusts a pricing value based on a contractual threshold.

6. The method of claim 1, further comprising persisting a result of the pricing calculation procedure to a storage system for use in subsequent billing operations.

7. The method of claim 1, wherein the first virtual table is generated by querying the ERP platform's condition index using at least one key field derived from a posted transaction.

8. A non-transitory, computer-readable medium containing instructions that, when executed by a hardware-based processor, causes the processor to perform stages for providing customized pricing logic in an Enterprise Resource Management (“ERP”) environment, comprising:
creating, using a condition index, a first virtual table that includes predetermined fields of transactional records identified for having an associated pricing condition;
comparing the transactional records in the first virtual table to a configuration file;
based on the comparison, creating a second virtual table that includes transactional records from the first virtual table that satisfy a first condition in the configuration file; and
applying a pricing calculation procedure using the transaction records in the second virtual table, the pricing calculation procedure being designated in the configuration file.

9. The non-transitory, computer-readable medium of claim 8, the stages further comprising distributing a result of the pricing calculation procedure by performing at least one of:
creating a new request item and copying one or more condition values from the pricing calculation result to the new request item; or
providing the pricing calculation result as input to a second pricing calculation procedure associated with a different set of transactional records.

10. The non-transitory, computer-readable medium of claim 8, wherein the configuration file includes a plurality of filters, each of the plurality of filters defining a condition for assigning transactional records to a corresponding pricing calculation procedure.

11. The non-transitory, computer-readable medium of claim 8, wherein the configuration file defines, for each condition, a corresponding pricing calculation procedure and a rule set for filtering transactional records based on one or more fields selected from: customer identifier, transaction type, material or service code, region, and effective date.

12. The non-transitory, computer-readable medium of claim 8, wherein the pricing calculation procedure comprises applying a conditional rule that adjusts a pricing value based on a contractual threshold.

13. The non-transitory, computer-readable medium of claim 8, the stages further comprising persisting a result of the pricing calculation procedure to a storage system for use in subsequent billing operations.

14. The non-transitory, computer-readable medium of claim 8, wherein the first virtual table is generated by querying the ERP platform's condition index using at least one key field derived from a posted transaction.

15. A system for providing customized pricing logic in an Enterprise Resource Management (“ERP”) environment, the system comprising:
at least one physical non-transitory, computer-readable medium including instructions; and
at least one processor that executes the instructions to perform stages comprising:

16. The system of claim 15, the stages further comprising distributing a result of the pricing calculation procedure by performing at least one of:
creating a new request item and copying one or more condition values from the pricing calculation result to the new request item; or
providing the pricing calculation result as input to a second pricing calculation procedure associated with a different set of transactional records.

17. The system of claim 15, wherein the configuration file includes a plurality of filters, each of the plurality of filters defining a condition for assigning transactional records to a corresponding pricing calculation procedure.

18. The system of claim 15, wherein the configuration file defines, for each condition, a corresponding pricing calculation procedure and a rule set for filtering transactional records based on one or more fields selected from: customer identifier, transaction type, material or service code, region, and effective date.

19. The system of claim 15, wherein the pricing calculation procedure comprises applying a conditional rule that adjusts a pricing value based on a contractual threshold.

20. The system of claim 15, the stages further comprising persisting a result of the pricing calculation procedure to a storage system for use in subsequent billing operations.
